(19) United States
(12) Patent Application Publication
(10) Pub. No.: US 2013/0298148 A1
(43) Pub. Date: Nov. 7, 2013

(54) INTERACTIVE TELEVISION SCRIPTING

(71) Applicant: Dauna R. Williams, Brooklyn, NY (US)

(72) Inventor: Dauna R. Williams, Brooklyn, NY (US)

(21) Appl. No.: 13/856,326

(22) Filed: Apr. 3, 2013

Related U.S. Application Data
(63) Continuation of application No. 09/752,925, filed on Jan. 2, 2001, now abandoned.
(60) Provisional application No. 60/173,980, filed on Dec. 30, 1999.

(51) Int. Cl. H04N 21/24; H04N 21/475

(52) U.S. Cl. CPC H04N 21/2408; H04N 21/4758
USPC 725/13

(57) ABSTRACT

A computer controlled system and method for creating an interactive television show incorporates audience feedback gathered by way of Internet software. Selected inputs include e-mail, as well as telephone and telecopy with these inputs influencing various levels of the script of upcoming episodes. The system provides for enhanced entry of comments and feedback, gathered by way of a calculated overlapping of questions, to allow structured incorporation of such feedback into the complex process for producing weekly and other episodic television shows. This invention further includes means for optimizing advertising revenues through Internet data gathering and dynamic feedback by character webmasters.

### CROSS REFERENCE TO RELATED APPLICATIONS

The present application is a continuation of U.S. application Ser. No. 09/752,925 filed Jan. 2, 2001, which is a nonprovisional of U.S. Provisional Application No. 60/173,980 filed Dec. 30, 1999. The contents of both applications are herein incorporated by reference in their entireties.

### BACKGROUND

1. Field of the Invention

The present invention generally relates to data processing systems and methods for managing a complex television episode development and production. More specifically, the present invention relates to the systems and methods for creating feedback controlled productions of television episodes wherein information is collected from viewers through a sophisticated processing network including Internet and web based collection sites.

2. State of the Art

Since its inception in the 1940's, television has entertained by methods including the presenting of fictional stories, which have typically been developed by an individual writer or team of writers with no audience feedback. Television is such a successful entertainment medium that it has penetrated practically every North American home. Despite the unrelenting encroachment of television into the everyday lives of the general population, writers of episodic shows and situational comedies have been and continue to be constrained to create their art prior to receiving any indication of public acceptance or other feedback. The advent of internet technology provides means for obtaining immediate audience feedback, which can be used to pro-actively adjust the coarse and subject of the television show to enrich story development.

### SUMMARY OF THE INVENTION

The invention represents convergence technology that works to incorporate audience feedback into later episodes to enhance the quality and audience acceptance of later shows by both broadening scripting possibilities and fulfilling audience expectations. Engendering audience participation will allow ready access to audience information, heightening the ability to effectively target future merchandising opportunities.

Akin to several contemporary television shows (e.g., Buffy The Vampire Slayer, The Bold And The Beautiful, etc.) the method of the present invention presents questions to the audience on its custom-designed “sister” internet homepage. Similar to the Internet “teaser” website developed to promote the recent Blair Witch Project movie, the “sister” homepage will also act to assure future audience attendance by displaying some limited information about upcoming episode(s). The present invention, however, utilizes its sister website to do more than simply poll or inform its audience. First, the type of question asked by the invention is distinguishable from those generally found on television shows' websites today: namely the invention queries will be prescribed to directly determine the show's story line, whereas the latter's are for more general individual quizzing, entertainment or indirect information gathering for the show's producers. Second, during each episode the intention's sister homepage will be updated simultaneously to reflect the events that transpired during the story. Third, the method of the invention incorporates and utilizes planned, systematic data gathered from audience feedback for creative and commercial purposes.

The purpose of the invention is to create shows that significantly reflect audience preferences. After the televised airing of the weekly TV or other show, the show's sister website will poll the audience to determine the direction that the storyline should take in future episodes. Audience members can also participate in the polling via toll-free 800, 877 and 888 numbers, Personal Digital Assistance (“PDAs”), email or by fax. The weekly poll will close after several days, at which time the TV production staff will finalize its incorporation of the audience feedback into various future episodes, with results appearing on air as early as one week later. Audience feedback that influences programming content may be collected directly from weekly audience polling, content-driven audience-authored email, chatroom discussions or Bulletin Board Services (“BBS”) postings, and other forms of viewer online participation (e.g., games, contests). Feedback also may be surmised from audience-preferences garnered from intelligence data collected from the story's e-commerce character-portals residing on the sister website.

The invention satisfies a yearning for entertaining interactivity by introducing new techniques to maximize the convergence of the extant static television scripting practices and of developing internet technologies to create a new paradigm for interactive entertainment. The invention enables delivery by exact, widely available, technology of content-rich “narrowband convergence” story telling experience.

The invention creates a link now missing in interactivity, namely, actualization of audience input in a product created by a production company for audience consumption. Under the invention, the audience now is an active participant in content production anticipated for its own consumption, by putting in place viewer-to-producer information sharing infrastructure.

Furthermore, the TV show acts as an innovative backdrop for modern e-commerce, by serving as: a “catalog” for online merchandising, a vehicle for product placement commercials, and, its website, as a repository for market intelligence. Enhancement of viewer ownership in the show's storyline will increase the audience's “stickiness” and allegiance to televised airing and the website's e-commerce activities. And because the e-commerce is being developed simultaneously with the show, both will be more organically integrated, and therefore, more seamless to the end-user. Viewer ownership would be a powerful tool for driving traffic across media platforms, opening new doors for user retention and leveraging. Transitioning the passive TV viewer into an active Web user enhances brand awareness and increases advertisers' exposure. A viewer invested in his/her story's content will become and remain attracted to the advertising and e-commerce opportunities associated with such content.

### BRIEF DESCRIPTION OF THE FIGURES

FIG. 1—Schematically portrays interrelation of audience, programming staff and internet.

FIGS. 2a and 2b—Diagrams comparing methods of receiving audience feedback.

### DETAILED DESCRIPTION

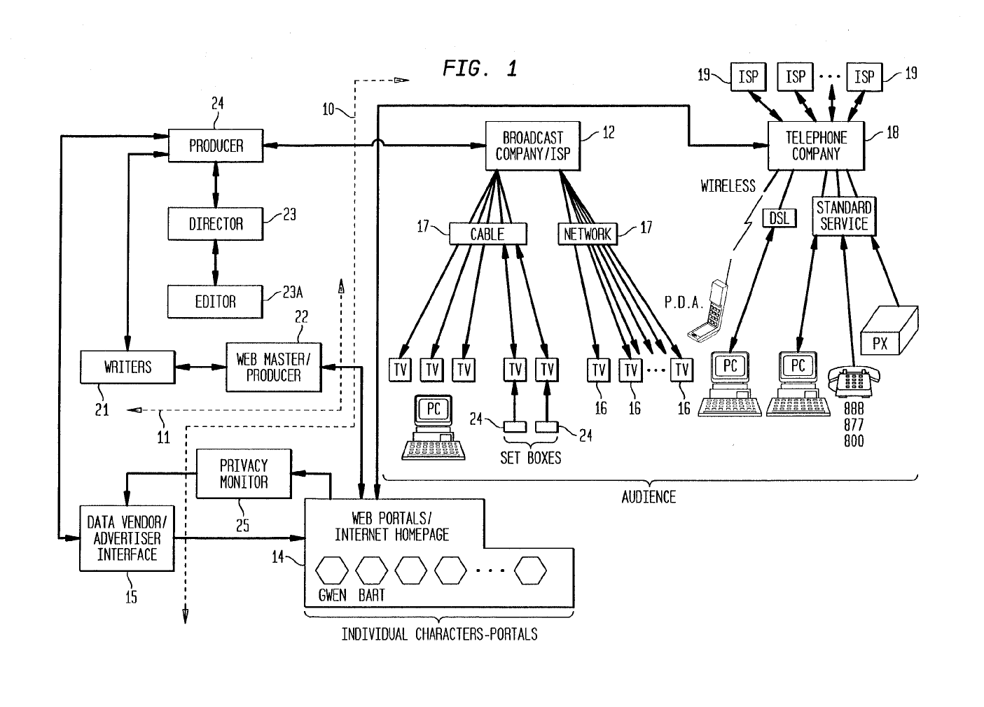

Although the preferred embodiment set out below demonstrates means for production of a television show, the invention is suitable and readily applicable to all media scripting, including, but not limited to, on-line streaming media, film and other visual/format(s) for storytelling. FIG. 1 is a schematic representation of the interrelation between the audience/viewers (10), production staff (11), broadcast company (12), internet and other methods of communicating with the audience (10), web portals/web producers (14), data vendors and advertising media (15), and the sub-components thereof.

The audience/viewer (10) component consists of the typical nationwide market, which receives data by way of transmission to television sets (16) via broadcast over open airwaves, encoded broadcast, and cable subscribers (17). Broadcast by way of transmission of signals over open airways and encoded broadcast is a unidirectional media. In contrast, audience members receiving the television transmission via cable and satellite network are increasingly choosing to utilize the broadband capability of the cable interface to enable bidirectional data exchange. A common mechanism for facilitating bidirectional transfer is the set-box (20), commonly known by one brand name WebTV. Of course, internet service providers (“ISPs”) (19) provide internet access to customers who do not have a set-box (20) applications. Presently, it is more typical for customers to access the internet by way of modem connected to standard or dedicated service line (“DSL”) telephone company line (18). Although interact access is the most ready method of obtaining audience feedback, alternate methods of obtaining audience feedback are provided and have the audience use specified toll-free 800, 877 or 888 number(s).

Production staff (11) is made up of the producers (24), director (23), editor (23a), writing staff (21), web master/producer (22), and support staff, collectively the production staff. The web master/producer (22) acts as the liaison between the computer programming personnel that operate the web portals (14), the on-air staff, namely, the “writers” (21), the director (23) and editor (23a).

The web portals (14) consists of typically automated means to monitor the audience participation and feedback. Managers of the web portals (14) consider requests from data vendors (15) and production staff (11) in their development of monitoring function and in the manner of tracking audience characteristics. The web portals (14) also have the responsibility for designing webpages that present to the audience queries received from production staff (11) as well as advertisements received from the data vendor (15).

A privacy monitor (25) is recommended to comply with federal child privacy protection statutes and other laws to ensure that audience loyalty and comfort is not sacrificed for myopic commercial gain.

The data vendor/advertiser interface (15) seek to leverage the continuous, typically real-time, information that is available from web portals and other means of gathering audience feedback.

A. Show Production

A.1 Overlapping Audience Questions:

Audience buy-in will not be obtained without the production staff (11) being able to include, in as timely a fashion as possible, the feedback received from the audience. This requires a careful pre-selection of questions and understanding how responses to each type of question will be incorporated into the developing script.

The preferred embodiment will present questions to the audience (“end user”) by way of a multi-tier system based on when each tier of questions can be integrated chronologically into the story. For example, responses to some of such questions can not and will not affect future shows airing as late as four weeks later (i.e., episode 4). It will not be apparent to the audience that a particular question can or cannot be immediately incorporated into the story due to this tiering of questions, and the segregation of questions between various character portals.

Examples of the tiered-based questioning of this invention are: the Editor-Driven Query (EDQ), Director-Driven Query (DDQ), Writer-Driven Query (WDQ) and the Online Request (OR). The EDQ, DDQ and WDQ are designed to elicit responses that can be utilized in various shows that will air from two to four weeks from questioning. The OR is a story-driving vehicle that is solicited from audience email, chatroom discussions or BBS postings, and is designed to air within one week from posting. The EDQ, DDQ, and WDQ questions are drafted by the show's staff, whereas, the OR is storyline-content that originates within the audience's imagination and then later is culled and incorporated by the staff into the show's storyline. Further explanation of this multi-tiered system is set out in Table 1, below.

TABLE 1

| | |
|---|---|
| 1. | EDO—Editor-Driven Scene/Query: |
| 1.1 | Added to the show's production the second to last day of principal |
| | editing. |
| 1.2 | Borrowing from the news show production style, this scene will |
| | involve limited characters and simple locations. |
| 1.3 | Generally, short in duration |
| 1.4 | Can serve as a foundation to future plot changes. |
| 1.5 | Can be accomplished by shooting alternative endings in principal |
| | photography (two weeks earlier) and placing the responsibility upon |
| | the editor to actualize the story's direction during assembly. |
| 1.6 | A second means to accomplish the same event would be to shoot the |
| | voted upon scene after the completion of principal photography, |
| | during post-production. Although the story's direction is not |
| | “actualized” by the editor per se, the onus to anticipate the |
| | later addition of footage is still upon the editor. |
| 1.7 | Airs two weeks after audience dictation. |
| 1.8 | This type of question generally will be geared more towards char- |
| | acter choices, of the “yes or no” variant (e.g., should she or |
| | shouldn't she) |
| 2. | DDQ—Director Driven Scene/Query: |
| 2.1 | Added to the Show's production during its preparation prior to |
| | shooting. |
| 2.2 | Director-driven change, (e.g., prop selection, actor choices). |
| 2.3 | Can serve as a plant for future pivotal moments. |
| 2.4 | The answer to this question generally will result more in a noun |
| | or adjective (e.g., manifesting itself in a prop or type of prop). |
| 3. | DQ—Writer Driven Scene/Query: |
| 3.1 | Effect the basis of that episode's direction. |
| 3.2 | Primarily derived from staff's answer road map and character |
| | algorithms. |
| 3.3 | A more complex answer that will generate a new subplot or fuel a |
| | former one, carrying on through subsequent episodes. |
| 4. | OR—Online Requests: |
| 4.1 | A vehicle that allows any audience member to participate in the |
| | storywriting via volunteered content sent to the show through email, |
| | chatroom discussions or BBS. |
| 4.2 | Such storyline must fit within the larger story context, and may or |
| | may not be expanded upon in future episodes. |
| 4.3 | Can be added to the show at the end of its future-lock up to its post- |
| | production. |

Below are example questions for EDQ, DDQ and WDQs.

TABLE 2
Example Audience Questions:
Story Recap: We are 8 weeks into the television season. Gwen, a vivacious lawyer, and Bart,
a NFL benchwarmer, recently have ended their 8-month relationship, due to Bart's
wandering eye and Gwen's workaholic behavior.
Gwen's Fan Questions for Week 9:

| | |
|---|---|
| 1. | “Why does Gwen want to reconcile with Bart?” |
| | So she can seek revenge on him after she's lulled him back |
| | Because she is now really interested in experiencing the two-way, “open” relationship |
| | he offered her before |
| | She's pregnant |
| 5. | “What is Gwen's favorite color?” |
| | Red |
| | Green |
| | Plum |
| | Blue |

Bart's Fan Questions for Week 9:

| | |
|---|---|
| 3. | “Should Bart give Gwen a second chance?” |
| | Yes |
| | No |

Those who answer “Yes” will then be prompted to answer the following question:

| | |
|---|---|
| 5. | “Why should Bart go back to Gwen? |
| | She's a convenient lay and keeps his house clean |
| | He needs a front for his homosexual lover |
| | Go back to her? He's just hungry and she offered to pay for dinner. Besides, her |
| | “upper deck” is always entertaining. |

Those who answer “No” will then be prompted to answer the following question:

| | |
|---|---|
| 5. | “Then who is going to do Bart's laundry while playing “French Maid?” |
| | Bart should hire a real housekeeper |
| | Gwen's friend Betsy |
| | Tell me, does the team's new rookie look French to you? |

Two days later, the audience answers are tallied and the most popular answers are as follows:
How Week 9's Answers Are Handled
Editor Driven Query (EDO) Scene:
Episode 11's scene answering the EDQ “Should Bart give Gwen a second chance?” was shot
two weeks earlier, with two endings.
Scene “Answering Machine Dilemma”: Bart walks out of the shower into his living room,
hearing for the first time Gwen's voice talking on his answering machine.
Ending 1 - Yes, give her a second chance.
Ending 2 - No, don't give her a second chance.
Bart walks over to his telephone, picks up the receiver and says hello.
Bart walks into his bedroom, leaving Gwen babbling into the machine.
Two weeks later the audience votes for Ending 1. The show is now in the hands of the
Editor who is instructed to use Ending 1 for the “Answering Machine Dilemma” scene. The
Editor discards Ending 2.
Director Driven Query (DDQ) Scene:
While Episode 11 is being edited, Episode 12 is being prepared for principal photography.
Episode 12's scene answering the Director-Driven DDQ question “What is Gwen's favorite
color?” is being prepped for shooting by the Director's team (which includes Wardrobe and
Props). The Assistant Director is instructed that the answer to the DDQ is “Blue” and that
she and the appropriate crew members should fill in scripts blanks accordingly.
INT. SOHO DRESS SHOP, DAY
Gwen debates between a slinky black dress or a softer, more conservative one.
After taking a deep breath, she sharply turns to the salesgirl and asks:

| | |
|---|---|
| GWEN | Which one is sexier? |
| SALESGIRL | Girl, the black one. |
| GWEN | Then I want this one. (She holds up the dress.) |
| | He's not worthy of eye candy . . . not yet. Besides is my lucky |
| | color . . . and I need all luck I can get. |

This information about Gwen (that blue is her favorite color) will become part of her
personal biography and weave itself into future episodes at pivotal moments (as well may her
blue dress).
Writer Driven Query (WDQ) Scene:
While Episode 11 is in editing and Episode 12 is in preparation for principal photography,
Episode 13 is with the writing team. Episode 13's WDQs are “Why does Gwen want to
reconcile with Bart?” and “Why should Bart go back to Gwen?”. The answers are,
respectively: “So Gwen can seek revenge on Bart after she's lulled him back” and “Go back
to her? This is just a free dinner with a view of her upper rack.” The writers than create a
dinner scene involving Gwen's conservative blue dress, a disappointed, “viewless” Bart, and
Gwen try to worm her way back into Bart's life and apartment. Bart shows no interest and
the evening ends with the two of them waiting for the other to pick up the check.
A.2 Production Deadlines:
Traditional television shows (both episodic and situation comedy) require minimally 6 to 8
weeks from script writing to air date. Several elements of this process that materially impact the
duration of product are:
shooting on film (additional development time) vs. video (developed in camera),
shooting on location (cast and crew movement, set decoration and location scouting)
vs. on a set (stationary workplace), and single camera (found in location shoots and
episodic shows, editing done else where) vs. multiple or three cameras (used with
sitcoms and soap operas, allows for simultaneous editing).

Television is a highly unionized industry and personnel carry out fast-paced, but regular working hours, generally with Saturday and Sundays off. Same day (or even same week) shooting and airing of televised material is relegated primarily to news, magazine and live shows and certain MTV programming. Table 3, below, outlines the most time consuming tasks associated with episodic and sitcom production.

A. Traditional Episodic Schedule (excludes weekends)

| | |
|---|---|
| 1. | 4-10 days writing a one (1) hour show. |
| 2. | 8 days prep (rehearsal, casting, location, scouting, etc.) of show |
| | No. 2, while 8 days simultaneously shooting show no. 1 (single |
| | camera, film) on location. |
| 3. | 28 days post-production to airing. |

(6.5-8 weeks total)
B. Traditional Sitcom Schedule (excludes weekends)

| | |
|---|---|
| 1. | 5-6 days writing a 30 minute show. |
| 2. | 1 day read through with actors |
| 3. | 2 days blocking with actors |
| 4. | 1 day dress rehearsal (shot - multi-camera, video) |
| 5. | 1 day live studio audience shoot (multi-camera, video) |
| 6. | 28 day post-production to airing |

(6 weeks total)
Engendering an aura of anticipation and script control will require an
audience-driven storyline television show (i.e., interactive) to reflect
interactivity sooner than 6 to 8 weeks. To accomplish this requires:

| | |
|---|---|
| 1. | Double-teaming of certain production units (namely, shooting |
| | and editing crews) |
| 2. | Removal of synchronized weekends for the production as a whole |
| | (i.e., each department will operate on it's own 5 day schedule as |
| | dictated by the needs of the show's production). |

It can readily be shown by way of reference to the timeframe examples that a traditional production schedule can be expedited to accommodate audience-enhanced feedback. Below is Table 4, outlining the activities necessary to produce a single episode.

TABLE 4
Production Schedule Outline for Episode 5
(4 weeks total, weekends included)

| | |
|---|---|
| Day 1 | Episode 1 airs; Producer approval of Episode 5 Writer |
| | Driven Queries |
| Day 2 | Writer Driven Queries for Episode 5 goes live |
| Day 3 | Writer Driven Queries for Episode 5 close and are tallied |
| Day 4-8 | Episode 5's script is written (5 days) |
| Day 8 | Episode 2 airs; Producer approval of Episode 5's Director |
| | Driven Queries |
| Day 9 | Director Driven Queries for Episode 5 goes live |
| Day 10 | Director Driven Queries for Episode 5 tallied; information |
| | conveyed to Assistant Director to implement during |
| | shoot |
| Day 7-11 | Episode 5's shooting prep (casting, rehearsals, location |
| | scouting, etc.) (5 days) |
| Days 12-18 | Episode 5's shoot, on location (“principal photography”) |
| | (6 days) |
| Days 14-19 | Editing (Assembly to Editor's Cut) (6 days) |
| Days 15 | Episode 3 airs; Producer approval of Episode 5 Editor |
| | Driven Queries |
| Day 16 | Editor Driven Queries for Episode 5 goes live |
| Day 17 | Editor Driven Queries for Episode 5 is tallied |
| Day 18 | Editor Driven scene for Episode 5 is “written” (early AM), |
| | then shot (PM) and delivered to Editor or Editor is directed |
| | to edit in the audience selected ending shot two weeks |
| | earlier |
| Days 20-24 | Producers'/Director's Editing/Cut (5 days) |
| Day 22 | Episode 4 airs; Online Requests are culled from website's |
| | email, chatrooms and bullet boards. “Impromptu” scene |
| | shot to run with either opening or closing credits and |
| | delivered to Editor for insertion in final reel. |
| Day 24 | Picture Lock Episode 5; Website begins coding new |
| | Merchandising |
| Day 25 | Music and Effects mix |
| Day 26 | Additional Dialogue Recording |
| Days 27-28 | Final mixing; Titling (2 days) |
| Day 28 | Producers' viewing (late) |
| Day 29 | Episode 5 airs. On website, new merchandising appears |
| | at airing and emceed Chatrooms open; Webmasters answer, |
| | email live. Simulcast choreography allows changes in |
| | televised storyline to appear in synch with changes on |
| | website. At close of Episode 5, story's archival |
| | information and other story-driven matter (video clips, |
| | music, question tallies, etc.) updated. Chatrooms emcees |
| | and Webmasters remain active after airing. |

The episode production portrayed in the above table is outlined in further detail in Table 5, which includes scheduling overlap for weeks 1-8.

TABLE 5
PRE-SEASON

| | PRE-SEASON | PRE-SEASON | PRE-SEASON | PRE-SEASON |
|---|---|---|---|---|
| | (3 months to Launch¹) | (5-6 Weeks to Launch) | (3-4 Weeks to Launch) | (2 Weeks to Launch) |
| STAFF | (June-August) | (Jul 15) | (late August-early September) | (September) |
| Producers | | Approve Road Maps | | |
| | | Approve questions for: | | |
| | | Ep. 2 - Editor Driven Query | | |
| | | (EDQ)² | | |
| | | Ep. 3 - Director Driven Query” | | |
| | | (DDQ)³ | | |
| | | Ep. 4 - Writer Driving Query | | |
| | | (WDQ)⁴ | | |
| Writers | Storyline Road Map | | | |
| | Audience Queries Road | | | |
| | Map | | | |
| | “Prequel-mercials⁵” scripts | | | |
| Episode Aired | | “Prequel-mercials⁶” (Set 1) | | “Prequel-mercials⁷” (Set 2) |
| Web Team | | Website live - platform launch | Questions Appear⁸ | Questions Closed/Tallied |
| | | coinciding with “prequel-mercials” | Ep. 2 - EDQ | Ep. 2 - EDQ |
| | | | Ep. 3 - DDQ | Ep. 3 - DDQ |
| | | | Ep. 4 - WDQ | Ep. 4 - WDQ |
| | | | Prequel-mercials (Set 1) | Prequel-mercials (Sets 1 & 2) |
| | | | streamed in | streamed in |

WEEK 1

| STAFF | WEEK 1/DAY 1 | DAY 2 | DAY 3 | DAY 4 | DAY 5 | DAY 6 | DAY 7 |
|---|---|---|---|---|---|---|---|
| Episode | Ep. 1 (Pilot) | | | | | | |
| Aired⁹ | | | | | | | |
| Producers¹⁰ | Approval of | Ep. 2 | Ep. 2 Picture | | | Ep. 3 | Viewing Ep. 2 |
| | Questions | Dir/Prod | Lock | | | Dir/Prod | (late) |
| | Ep. 3 - EDQ | Edit | Review & | | | Edit Begins | Ep. 3 Dir/Prod |
| | Ep. 4 - DDQ | Review & | comment on | | | | Edit |
| | Ep. 5 - WDQ | comment | Ep. 4 Script | | | | |
| | Ep. 2 Dir/Prod | on Ep. 4 | | | | | |
| | Edit | Script | | | | | |
| Web Team¹¹ | At time of Ep. 1 | Questions | Ep. 3, Ep. 4 | Ep. 2 | Ongoing Web | | |
| | airing: | Appear: | and Ep. 5 | Coding | Interactive | | |
| | New | Ep. 3 - EDQ | Monitored | Begins (for | Programming | | |
| | Merchandising | Ep. 4 - DDQ | Strategy | merchandising, | Contest/games | | |
| | Emceed chat | Ep. 5 - WDQ | Chatroom | archives, | Fan chatrooms, | | |
| | rooms open | | for Audience | video, music, | video interviews | | |
| | Active webmasters' | | Questions | audio and | with cast | | |
| | emailing | | Closed/Tallied¹²: | text) (after | Ongoing | | |
| | After Ep. 1 airing: | | Ep. 3 - EDQ | Picture Lock) | Portal Services | | |
| | Update archives | | Ep. 4 - DDQ | | Character | | |
| | Continue | | Ep. 5 - WDQ | | driven links | | |
| | chatrooms and | | | | Customized pages | | |
| | email | | | | Opt-in emailed | | |
| | Update video, | | | | newsletters | | |
| | music, audio | | | | Email services | | |
| | and text | | | | Show archives | | |
| | | | | | (clips, episode | | |
| | | | | | summaries, tally | | |
| | | | | | histories, etc. | | |
| Writers¹³ | Ep. 4 Tone | Off | Off | Ep. 4 Prod | Ep. 5 - | Ep. 5 - | Ep. 5 |
| | Meeting¹⁴ with | | | comments | Script/Qs | Script/Qs | Script/Qs |
| | Director | | | Receive Ep. | | | Questions to |
| | Ep. 4 Script Lock | | | 5 WDQ tally | | | Producers |
| | | | | Ep. 5 - | | | Ep. 4 - EDQ |
| | | | | Script/Qs¹⁵ | | | Ep. 5 - DDQ |
| | | | | Meeting | | | Ep. 6 - WDQ |
| | | | | with | | | |
| | | | | Webmasters, | | | |
| | | | | re: last | | | |
| | | | | night's | | | |
| | | | | Strategy | | | |
| | | | | Chat vibe | | | |
| Prep | Ep. 4 Prep | Ep. 4 | Ep. 4 Prep | OffOff | Ep. 5 | | |
| Team¹⁶ | Ep. 4 Tone Meeting | PrepEp. 4 | Receive and | | Prep | | |
| | with Writer and | Prep | implement | | | | |
| | Director | | Ep. 4's DDQ | | | | |
| | | | tally. | | | | |
| Shoot | Ep. 3 Shoot¹⁸ | Off | Off | Ep. 4 Baton | Ep. 4 | Ep. 4 | Ep. 4 |
| Team A¹⁷ | | | | Pass¹⁹ | Shoot | Shoot | Shoot |
| Shoot | Ep. 3 B roll | Ep. 3 | Ep. 3 | Ep. 3 Shoot/B | Off | Off | Off |
| Team B | Ep. 3 Baton | Shoot | Shoot | Roll (whatever | | | |
| | Pass²⁰ | | | needed) | | | |
| Editors²¹ | Ep. 2 Dir/Prod Edit | Ep. 2 | Ep. 2 Picture | Receive and | Ep. 3 | Ep. 3 | Ep. 3 |
| | Ep. 3 Edit | Dir/Prod | Lock | edit in Ep. | Editor's | Dir/Prod | Dir/Prod |
| | | Edit | Ep. 3 Edit | 3's EDQ | Cut²² | Edit Begins | Edit |
| | | Ep. 3 | | tally | | | Ep. 4 Edit |
| | | Edit | | Ep. 3 Edit | | | Begins |
| Post Team²³ | | | | Ep. 2 - Music | Ep. 2 - | Ep. 2 | Ep. 2 |
| | | | | and Effects | Additional | Final Mix | Final Mix |
| | | | | (M&E) | Dialogue | | Ep. 2 Titling |
| | | | | | Recording | | |
| | | | | | (ADR) | | |

WEEK 2

| STAFF | WEEK 2/DAY 8 | DAY 9 | DAY 10 | DAY 11 | DAY 12 | DAY 13 | DAY 14 |
|---|---|---|---|---|---|---|---|
| Episode | Ep. 2 | | | | | | |
| Aired | | | | | | | |
| Producers | Approval of | Ep. 3 | Ep. 3 Picture | | | Ep. 4 | Viewing |
| | Questions | Dir/Prod | Lock | | | Dir/Prod | Ep. 3 (late) |
| | Ep. 4 - EDQ | Edit | Review & | | | Edit Begins | Ep. 4 |
| | Ep. 5 - DDQ | Review & | comment on | | | | Dir/Prod Edit |
| | Ep. 6 - WDQ | comment on | Ep. 5 Script | | | | |
| | Ep. 3 Dir/Prod | Ep. 5 Script | | | | | |
| | Edit | | | | | | |
| Web Team | At time of Ep. 2 | Questions | Ep. 4, Ep. 5 | Ep. 3 | Ongoing Web | | |
| | airing: | Appear: | and Ep. 6 | Coding | Interactive | | |
| | New | Ep. 4 - EDQ | Monitored | Begins (for | Programming | | |
| | Merchandising | Ep. 5 - DDQ | Strategy | merchandising, | Contest/games | | |
| | Emceed chat | Ep. 6 - WDQ | Chatroom | archives, | Fan chatrooms, | | |
| | rooms open | | for Audience | video, music, | video interviews | | |
| | Active webmaster's | | Questions | audio and | with cast | | |
| | emailing | | Closed/Tallied: | text) (after | Ongoing | | |
| | After Ep. 2 airing: | | Ep. 4 - EDQ | Picture Lock) | Portal Services | | |
| | Update archives | | Ep. 5 - DDQ | | Character | | |
| | Continue | | Ep. 6 - WDQ | | driven links | | |
| | chatrooms and | | | | Customized pages | | |
| | email | | | | Opt-in emailed | | |
| | Update video, | | | | newsletters | | |
| | music, audio | | | | Email services | | |
| | and text | | | | Show archives | | |
| | | | | | (clips, episode | | |
| | | | | | summaries, tally | | |
| | | | | | histories, etc. | | |
| Writers | Ep. 5 Tone | Off | Off | Ep. 5 Prod | Ep. 6 - | Ep. 6 - | Ep. 6 |
| | Meeting with | | | comments | Script/Qs | Script/Qs | Script/Qs |
| | Director | | | Receive Ep. 6 | | | Questions to |
| | Ep. 5 Script | | | WDQ tally | | | Producers |
| | Lock | | | Ep. 6 - | | | Ep. 5 - EDQ |
| | | | | Script/Qs | | | Ep. 6 - DDQ |
| | | | | Meeting with | | | Ep. 7 - WDQ |
| | | | | Webmasters, | | | |
| | | | | re: last night's | | | |
| | | | | Strategy Chat | | | |
| | | | | vibe | | | |
| Prep | Ep. 5 Prep | Ep. 5 Prep | Ep. 5 Prep | Ep. 5 Prep | Off | Off | Ep. 6 |
| Team | Ep. 5. Tone | | | Receive and | | | Prep |
| | meeting with | | | implement | | | |
| | Writers and | | | Ep. 5's DDQ | | | |
| | Director | | | tally. | | | |
| Shoot | Ep. 4 Shoot | Off | Off | Ep. 5 | Ep. 5 | Ep. 5 | Ep. 5 |
| Team A | | | | Baton Pass | Shoot | Shoot | Shoot |
| Shoot | Ep. 4 B roll | Ep. 4 Shoot | Ep. 4 Shoot | Ep. 4 Shoot/B | Off | Off | Off |
| Team B | Ep. 4 Baton | | | Roll (whatever | | | |
| | Pass | | | needed) | | | |
| Editors | Ep. 3 | Ep. 3 | Ep. 3 Picture | Receive and | Ep. 4 | Ep. 4 | Ep. 4 |
| | Dir/Prod Edit | Dir/Prod Edit | Lock | edit in Ep. 4's | Editor's | Dir/Prod | Dir/Prod Edit |
| | Ep. 4 Edit | Ep. 4 Edit | Ep. 4 Edit | EDQ tally | Cut | Edit Begins | Ep. 5 Edit |
| | | | | Ep. 4 Edit | | | Begins |
| Post Team | | | | Ep. 3 - Music | Ep. 3 - | Ep. 3 | Ep. 3 |
| | | | | and Effects | Additional | Final Mix | Final Mix |
| | | | | (M&E) | Dialogue | | Ep. 3 Titling |
| | | | | | Recording | | |
| | | | | | (ADR) | | |

WEEK 3

| STAFF | WEEK 3/DAY 15 | DAY 16 | DAY 17 | DAY 18 | DAY 19 | DAY 20 | DAY 21 |
|---|---|---|---|---|---|---|---|
| Episode | Ep. 4 | | | | | | |
| Aired | | | | | | | |
| Producers | Approval of | Ep. 4 | Ep. 4 Picture | | | Ep. 5 | Viewing |
| | Questions | Dir/Prod | Lock | | | Dir/Prod | Ep. 4 (late) |
| | Ep. 5 - EDQ | Edit | Review & | | | Edit Begins | Ep. 5 |
| | Ep. 6 - DDQ | Review & | comment on | | | | Dir/Prod Edit |
| | Ep. 7 - WDQ | comment on | Ep. 6 Script | | | | |
| | Ep. 4 Dir/Prod | Ep. 6 Script | | | | | |
| | Edit | | | | | | |
| Web Team | At time of Ep. 4 | Questions | Ep. 5, Ep. 6 and | Ep. 4 | Ongoing Web | | |
| | airing: | Appear: | Ep. 7 Monitored | Coding | Interactive | | |
| | New | Ep. 5 - EDQ | Strategy | Begins (for | Programming | | |
| | Merchandising | Ep. 6 - DDQ | Chatroom for | merchandising, | Contest/games | | |
| | Emceed chat | Ep. 7 - WDQ | Audience | archives, | Fan chatrooms, | | |
| | rooms open | | Questions | video, music, | video interviews | | |
| | Active webmaster's | | Closed/Tallied: | audio and | with cast | | |
| | emailing | | Ep. 5 - EDQ | text) (after | Ongoing | | |
| | After Ep. 4 airing: | | Ep. 6 - DDQ | Picture Lock) | Portal Services | | |
| | Update archives | | Ep. 7 - WDQ | | Character | | |
| | Continue | | | | driven links | | |
| | chatrooms and | | | | Customized pages | | |
| | email | | | | Opt-in emailed | | |
| | Update video, | | | | newsletters | | |
| | music, audio | | | | Email services | | |
| | and text | | | | Show archives | | |
| | | | | | (clips, episode | | |
| | | | | | summaries, tally | | |
| | | | | | histories, etc. | | |
| Writers | Ep. 6 Tone | Off | Off | Ep. 6 Prod | Ep. 7 - | Ep. 7 - | Ep. 7 |
| | Meeting with | | | comments | Script/Qs | Script/Qs | Script/Qs |
| | Director | | | Receive Ep. 7 | | | Questions to |
| | Ep. 6 Script | | | WDQ tally | | | Producers |
| | Lock | | | Ep. 7 - | | | Ep. 6 - EDQ |
| | | | | Script/Qs | | | Ep. 7 - DDQ |
| | | | | Meeting with | | | Ep. 8 - WDQ |
| | | | | Webmasters, | | | |
| | | | | re: last night's | | | |
| | | | | Strategy Chat | | | |
| | | | | vibe | | | |
| Prep | Ep. 6 Prep | Ep. 6 Prep | Ep. 6 Prep | Ep. 6 Prep | Off | Off | Ep. 7 |
| Team | Ep. 6, Tone | | | Receive and | | | Prep |
| | meeting with | | | implement | | | |
| | Writers and | | | Ep. 6's DDQ | | | |
| | Director | | | tally. | | | |
| Shoot | Ep. 5 Shoot | Off | Off | Ep. 6 | Ep. 6 | Ep. 6 | Ep. 6 |
| Team A | | | | Baton Pass | Shoot | Shoot | Shoot |
| Shoot | Ep. 5 B roll | Ep. 5 Shoot | Ep. 5 Shoot | Ep. 5 Shoot/B | Off | Off | Off |
| Team B | Ep. 5 Baton | | | Roll (whatever | | | |
| | Pass | | | needed) | | | |
| Editors | Ep. 4 | Ep. 4 | Ep. 4 Picture | Receive and | Ep. 5 | Ep. 5 | Ep. 5 |
| | Dir/Prod Edit | Dir/Prod Edit | Lock | edit in Ep. 5's | Editor's | Dir/Prod | Dir/Prod Edit |
| | Ep. 5 Edit | Ep. 5 Edit | Ep. 5 Edit | EDQ tally | Cut | Edit Begins | Ep. 6 Edit |
| | | | | Ep. 5 Edit | | | Begins |
| Post Team | | | | Ep. 4 - Music | Ep. 4 - | Ep. 4 | Ep. 4 |
| | | | | and Effects | Additional | Final Mix | Final Mix |
| | | | | (M&E) | Dialogue | | Ep. 4 Titling |
| | | | | | Recording | | |
| | | | | | (ADR) | | |

WEEK 4

| STAFF | WEEK 4/DAY 22 | DAY 23 | DAY 24 | DAY 25 | DAY 26 | DAY 27 | DAY 28 |
|---|---|---|---|---|---|---|---|
| Episode | Ep. 4 | | | | | | |
| Aired | | | | | | | |
| Producers | Approval of | Ep. 5 | Ep. 5 Picture | | | Ep. 6 | Viewing |
| | Questions | Dir/Prod | Lock | | | Dir/Prod | Ep. 5 (late) |
| | Ep. 6 - EDQ | Edit | Review & | | | Edit Begins | Ep. 6 |
| | Ep. 7 - DDQ | Review & | comment on | | | | Dir/Prod Edit |
| | Ep. 8 - WDQ | comment on | Ep. 7 Script | | | | |
| | Ep. 5 Dir/Prod | Ep. 7 Script | | | | | |
| | Edit | | | | | | |
| Web Team | At time of Ep. 4 | Questions | Ep. 6, Ep. 7 | Ep. 5 | Ongoing Web | | |
| | airing: | Appear: | and Ep. 8 | Coding | Interactive | | |
| | New | Ep. 6 - EDQ | Monitored | Begins (for | Programming | | |
| | Merchandising | Ep. 7 - DDQ | Strategy | merchandising, | Contest/games | | |
| | Emceed chat | Ep. 8 - WDQ | Chatroom for | archives, | Fan chatrooms, | | |
| | rooms open | | Audience | video, music, | video interviews | | |
| | Active webmaster's | | Questions | audio and | with cast | | |
| | emailing | | Closed/Tallied: | text) (after | Ongoing | | |
| | After Ep. 4 airing: | | Ep. 6 - EDQ | Picture Lock) | Portal Services | | |
| | Update archives | | Ep. 7 - DDQ | | Character | | |
| | Continue | | Ep. 8 - WDQ | | driven links | | |
| | chatrooms and | | | | Customized pages | | |
| | email | | | | Opt-in emailed | | |
| | Update video, | | | | newsletters | | |
| | music, audio | | | | Email services | | |
| | and text | | | | Show archives | | |
| | | | | | (clips, episode | | |
| | | | | | summaries, tally | | |
| | | | | | histories, etc. | | |
| Writers | Ep. 7 Tone | Off | Off | Ep. 7 Prod | Ep. 8 - | Ep. 8 - | Ep. 8 |
| | Meeting with | | | comments | Script/Qs | Script/Qs | Script/Qs |
| | Director | | | Receive Ep. 8 | | | Questions to |
| | Ep. 7 Script | | | WDQ tally | | | Producers |
| | Lock | | | Ep. 8 - | | | Ep. 7 - EDQ |
| | | | | Script/Qs | | | Ep. 8 - DDQ |
| | | | | Meeting with | | | Ep. 9 - WDQ |
| | | | | Webmasters, | | | |
| | | | | re: last night's | | | |
| | | | | Strategy Chat | | | |
| | | | | vibe | | | |
| Prep | Ep. 7 Prep | Ep. 7 Prep | Ep. 7 Prep | Ep. 7 Prep | Off | Off | Ep. 8 |
| Team | Ep. 7. Tone | | | Receive and | | | Prep |
| | meeting with | | | implement | | | |
| | Writers and | | | Ep. 7's DDQ | | | |
| | Director | | | tally. | | | |
| Shoot | Ep. 6 Shoot | Off | Off | Ep. 7 | Ep. 7 | Ep. 7 | Ep. 7 |
| Team A | | | | Baton Pass | Shoot | Shoot | Shoot |
| Shoot | Ep. 6 B roll | Ep. 6 Shoot | Ep. 6 Shoot | Ep. 6 Shoot/B | Off | Off | Off |
| Team B | Ep. 6 Baton | | | Roll (whatever | | | |
| | Pass | | | needed) | | | |
| Editors | Ep. 5 | Ep. 5 | Ep. 5 Picture | Receive and | Ep. 6 | Ep. 6 | Ep. 6 |
| | Dir/Prod Edit | Dir/Prod Edit | Lock | edit in Ep. 6's | Editor's | Dir/Prod | Dir/Prod Edit |
| | Ep. 6 Edit | Ep. 6 Edit | Ep. 6 Edit | EDQ tally | Cut | Edit Begins | Ep. 7 Edit |
| | | | | Ep. 6 Edit | | | Begins |
| Post Team | | | | Ep. 5 - Music | Ep. 5 - | Ep. 5 | Ep. 5 |
| | | | | and Effects | Additional | Final Mix | Final Mix |
| | | | | (M&E) | Dialogue | | Ep. 5 Titling |
| | | | | | Recording | | |
| | | | | | (ADR) | | |

NOTE:
EPISODE 5 AIRS ON DAY 29 OF WEEK 5.
¹For purposes of this chart, “Launch Date” is late September.
²An EDQ or Editor Driven Query (a.k.a. “Drop-In Scene” or “DIS” query) will result in a very short scene that can be shot either: (a) last minute, in less than a half a day by Cameral B Crew, right before Editor's Cut, or (b) shot twice with different endings during Principal Photography. Under the preferred Scenario (b), the change is solely “Editor Driven.”
³A DDQ or Director Query (a.k.a. “Flavor Query” or “FQ”) will effect the tenor of a subplot storyline. It is written so that accommodating the resulting tally is “Director-Driven” (i.e., can be addressed in Preparation for Principal Photography).
⁴A WDQ or Writer Driven Query (a.k.a. “Story Driving Query” or “SDQ”) will effect more pivotal plot changes in storyline, being the basis of an Episode's storyline. Implementing SDQ answers is a “Writer-Driven” task.
⁵As part of launch marketing, and to facilitate interactivity earlier in the season, “Prequel-mercials” (story-driven commercials (product driven 30-60 second films)) will be used both for marketing the show and engaging audience participation prior to airing. Prequel-mericials will air 4-6 weeks before TV launch date. Website will begin its platform launch with airing of Prequel-mercials. Questions for TV Episode 2 will appear 3 weeks before airing Episode 1 (not interactive if pilot (previously shot in Spring) is used in this slot).
⁶First set of Prequel-mercials is setting up primarily Ep. 2's DIS and Ep. 3's FQ, relegating only one question to Ep. 4's SDQ (Why? Because prequel-mercial format may not be sufficient to gamer a sophisticated SDQ response from an unseasoned audience).
⁷Second set of Prequel-mercials is focused on Ep. 3's DIS, Ep. 4's FQ and Ep. 5's SDQ. This second set will air up to Launch (approximately 2 weeks).
⁸After written by Writers and approved by Producers, Questions appear on Website (character portals), on toll-free (e.g., 800, 888 or 887) number and are sent to requesting audience participants by email or fax. Answers may be received by Show via Website, return email, fax (scanned) or 800 number. Optional: if limiting audience participation to one character, a registration and password program will have to be implemented and “blocking software” prohibiting repeat online voting. Story questions may go live 3 AM EDT after Show's airing (to accommodate network affiliates' concerns about losing viewer traffic) and are tallied 45 to 48 hours later.
⁹At TV airtime, new Merchandising (character/story driven online buying opportunities) associated with that Episode go live on the website. Chatrooms Emcees and Webmasters are live for online commentary/response.
¹⁰“Producers” include Company and Network Producers. When appropriate other senior staff members, e.g., Directors, may be included.
¹¹“Web Update” occurs right after the TV show closes and consists of updating archives, continuing monitored Chat Room and Email commentary, adding recent show synopsis and other story/audience-driven updating (text, video and music). “Web Update Team” (for both TV Airtime and post-Airtime activity) consists of primarily 1-IMTL Programmers, Content Editors, Web Producers, Designers, etc.
¹²Closing either 45 hours (i.e., midnight EDT) or 48 hours (i.e., 3 AM EDT, Day 4), which ever is more viewer-friendly. Only time constraint is to have computer tally completed by time crew/staff arrive in morning on Day 4. Tallied answers are delivered to the following departments for implementation: DIS tally to Editor, FQ tally to Director and SDQ to Writers.
¹³Writer(s) will be assigned to each Episode, and will write his/her Episode's Drop-In Scene and Flavor Query scenes, questions, potential outcomes and Editor/Director instructions. The larger unwritten SDQ story (in this case, Episode 5), will be based on advertiser/network approved Story Roadmaps (written during summer before Airing) and Audience Answers.
¹⁴In a “tone meeting” the Writer (and/or Executive Producer) conveys to the Director his/her intentions in the script and the Director expresses any production concerns.
¹⁵Also writing Ep. 5's future DIS and FQ questions, with alternate endings for DIS and crew instructions for Editor and Director, respectively. Ep. 6's SDQ is being written at this time too.
¹⁶“Prep Team” consists of primarily Director, Assistant Directors, Location Managers, Casting Directors, Production Managers, Propmasters, Costumers, Set Designers and all others responsible for facilitating Rehearsals, Casting, Location Scouting and Shoot Scheduling, etc.
¹⁷“Shooting Team” is responsible for Principal Photography consists of primarily those listed above and Camera, Sound, Lighting crews, etc. Note: To best accommodate union rules and human needs, the Prep Team and Shooting Team will consist of separate staff (except Director, who will follow his/her respective episode from start to finish), although the job descriptions are the same.
¹⁸For this chart, “Shoot” means Principal Photography.
¹⁹“Baton Pass” (informational exchange) between Prep Team and Shoot Team A. Director off. Handled by First AD.
²⁰Baton pass between Shoot Team's A & B.
²¹Just like Writers and Directors, Editors will be assigned to follow from beginning to end, the major portions of an Episode (i.e., on Editor will be responsible for bringing the edit through the Editor's Cut, and another for Picture Lock).
²²Editor's version of show is complete and ready for Director/Producer's review and comment.
²³“Post Team” consists of primarily Film Editors, Sound Editors, Music Composers, Soundtrack, Mixers and others responsible for facilitating Post-Production, (i.e., Picture Editing, Sound Editing, Music & Effects (M&E) mixing, Additional Dialogue Recording (ADR), Telecine transfer (film to tape transfer) and Titling, etc.). This chart assumes the Show will be shot on video, and therefore does not account for a Telecine transfer.

### The Audience Voice

Currently, audience feedback can not be directly obtained. Separate advertiser survey companies or rating agencies typically produce reports (e.g., Nielson reports) that are used to monitor audience acceptance of a show. Such reports suffer from an inherent time delay, the fact that they are developed by third-parties and depend heavily on time-consuming diaries and integrity of viewer pool. Although such reports are insightful, they offer lesser value to the individuals engaged in writing, editing, producing and directing a television series (collectively the “production staff”) or other broadcast that must air new material within relatively short intervals.

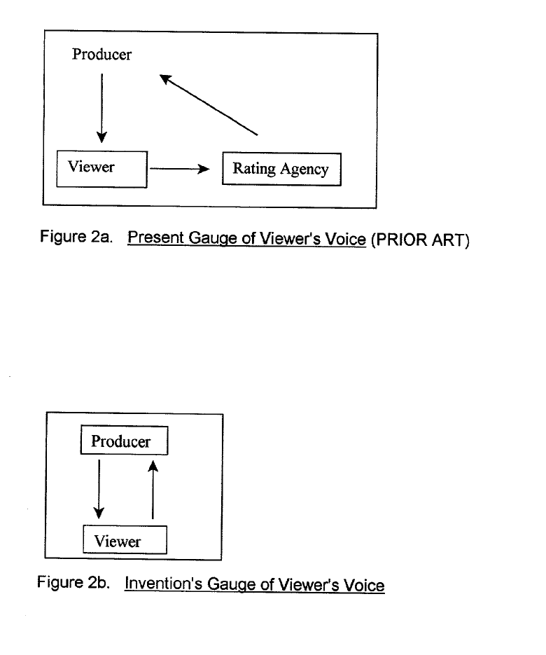

The method presented by the invention provides a novel solution to a critical deficiency in the current system. First, the invention allows the production staff to bypass the third-party rating agency and obtain viewer feedback. See FIG. 2b.

Second, the invention allows the production staff to obtain viewer feedback immediately after—and, for some purposes, during—show broadcast. Third, the production staff can purposely leave unplanned. certain future story events and, instead, write questions whose responses will provide direction for such events.

For purposes of story development, audience feedback is filtered predominantly by method of whether the question responded to is an EDQ, DDQ, WDQ or OR. It is anticipated that one or more character webmaster(s) (22) will be assigned the task of gathering the feedback and communicating with the writers (21), editors (23a), directors (22) and producers (24), thereby serving as an enabler of audience choice.

For purposes of advertiser interest/economics, audience feedback gathered from the website/portals and other real-time data is of premium value. While, as described above, such immediate feedback is valuable for determination of preferred character traits, for determination of preferred storyline development and for creation of a more dynamic means of storytelling; such immediate feedback can better enable marketers to market their product by having immediately available information on audience preferences, show/character popularity, audience buying habits, and, or course, audience web-browsing habits. The method of this invention provides a planned means for advertisers to almost simultaneously garner feedback from a significant number of the actual audience members. Such valuable data was formerly only available by conducting focus groups, an expensive and less accurate exercise. To obtain such feedback from a significant percentage of the audience, advertisers and show producers had to wait for third party reports, which, due to presence of the third party polling agency, can be inherently inaccurate and only indirectly satisfy the unique demands of both the advertisers of the show developers.

The most immediate manner in which audience feedback data can be obtained using the method of the present invention is by real-time monitoring of the character portals (14), over which the advertisers and show producers can exercise direct control.

### Economic Activities and Advertising Advantages:

In the preferred embodiment, each main character will have his/her own portal (14), where their weekly audience questions will reside. On each character portal (14), online merchandising of the character's possessions (clothing, furniture, etc.) can be purchased. Character-driven banner and hyperlink advertisements will also reside on each portal (14). Chatrooms and fan email (designated character webmaster) allow for interactivity to continue when the show is not on air. Archives (text, video and audio/music) are available for audience member research and entertainment. The e-commerce rich portals will facilitate the collecting of detailed customer intelligence, therefore enabling targeted marketing by advertisers (15), if so desired. Several advertising and e-commerce vehicles crossing hardcopy, television and internet platforms, including:
Advertising sales (“prequel-mercials,” “webmercials,” other online advertising and print advertising in newsletter)
Online merchandising commissions (third-party sales) and retail sales of TV show characters' clothing, make-up, props found on TV set (furnishings, appliances etc.) and soundtrack music (MP3), etc., with parallel offline catalog
Licensed merchandise sales (online and catalog)
Affinity programs with online and offline retailers
Banner ads, buttons and links/affiliate programs
Traffic data aggregation and analysis
Opt-in email and other offline direct marketing campaigns
Fan club membership, subscription newsletters (on and offline) and other premium fan portal services. As an incentive for fan club membership, fans may be granted weighted voting rights.

### The “Prequel-Mercial”—

In order to simulate interactivity early in the TV season with an educated audience (10), a convergence of advertising, storytelling and interactivity can occur, namely by way of the “prequel-mercial.” Prequel-mercials are story driven commercials of 30-60 second duration that sell product and entice viewership. As part of launch, “prequel-mercials” can be used both for marketing the show and engaging future audience participation. Although primarily a story content vehicle, the expense of prequel-mercials can be subsidized by consumer item product placement. Also, this format can be used throughout the season for strategic storytelling and as a general advertising vehicle for show sponsors.

Distinct Regional Subplots/Spin-Offs—

Further anticipated by the invention is the creation of distinct regional subplots, spun-off from the main show. Such stand alone regional sub-stories will “air” online, via streaming media video, and will have story lines that are uniquely generated and modified by regional viewers and supported by local advertising.

I claim:

1. A method of scripting, directing, writing or producing a show by presenting, in an automated manner, one or more queries to the audience where such queries are designed by either a producer, a writer, or a director of the show to elicit a feedback that can be utilized or that is utilized in the scripting or development of the initial show or for later shows.

2. The method of claim 1 used to produce a television or online series of situational comedies, episodic shows or soap operas.

3. The method of claim 1 using streaming media, non-streaming online media, television or other manner of visual or audio format for storytelling.

4. The method of claim 1 with such queries structured in a multi-tiered manner based on when each tier of questions can be incorporated into the story.

5. The method of claim 1 with an additional tier of such queries that can be immediately incorporated into the television show production.

6. The method of claim 1 utilizing interne and other means to present and to gather responses to such queries.

7. The method of claim 1 to garner from viewer portals and other means of electronic feedback to analyze audience behavior.

8. The method of claim to report such audience behavior to advertisers, producers, directors, writers, broadcasters or studios.

9. The method of claim 1 wherein such end user feedback received by way of email or other means can be incorporated into the show scheduled for broadcast within seven days.

10. The method of claim 1 to engender viewership.

11. The method of claim 1 utilizing a prequel-mercial to engender audience interest.

12. The method of claim 1 utilizing a prequel-mercial to enable non-temporally limited feedback.

13. The method of claim 1 utilizing a prequel-mercial to garner feedback for initial episodes.

14. The method of claim 1 utilizing a prequel-mercial to educate the audience about the show.

15. The method of claim 1 utilizing a prequel-mercial to promote the show or to otherwise increase audience size or participation.

16. The method of claim 1 utilizing a prequel-mercial to provide portions of the storyline that are supportive of the upcoming show(s).

17. The method of claim 16 wherein said prequel-mercial comprises product placement advertisement within such storyline.
